(19) United States
(12) Patent Application Publication
(10) Pub. No.: US 2016/0355060 A1
(43) Pub. Date: Dec. 8, 2016

(54) TIRE MARKING APPARATUS

(71) Applicant: MITSUBISHI HEAVY INDUSTRIES MACHINERY TECHNOLOGY CORPORATION, Hiroshima-shi (JP)

(72) Inventors: Kunio MATSUNAGA, Hiroshima-shi (JP); Tatsuya UEDA, Hiroshima-shi (JP); Morihiro IMAMURA, Hiroshima-shi (JP); Hiroaki YONEDA, Hiroshima-shi (JP)

(73) Assignee: Mitsubishi Heavy Industries Machinery Technology Corporation

(21) Appl. No.: 14/910,876

(22) PCT Filed: Feb. 5, 2015
(86) PCT No.: PCT/JP2015/053210

§ 371 Date: Feb. 8, 2016

(51) Int. Cl. B60C 13/00; B41J 3/407; B29D 30/72

(52) U.S. Cl. CPC B60C 13/001; B29D 30/72; B41J 3/4073; B29D 2030/728

(57) ABSTRACT

A tire marking apparatus for performing marking in a tire includes a printing part capable of performing printing in a tire; a rotational position adjusting roller that abuts against a portion of the tire, and rotates the tire around an axis of the tire when the rotational position adjusting roller rotates; and a rotational driving unit that rotates the rotational position adjusting roller.

### TECHNICAL FIELD

The present invention relates to a tire marking apparatus for performing marking in a tire.

### BACKGROUND ART

It is required that tire marking apparatuses (hereinafter also simply referred to as “marking apparatuses”) that perform marking in tires are included in equipment that tests and inspects completed tires, such as tire uniformity machines that measure the non-uniformity of tires or balancing machines that measure the unbalance of tires.

In the marking apparatuses, it is required that marks, such as circular shapes or triangular shapes, are dotted (marking is performed) at circumferential positions (phases) of a tire, which are determined from measurement results and criteria for determination, on a sidewall of the tire.

Various shapes and colors of the marks have been required in recent years, and a plurality of marks may be required for a tire.

As the types of positions where marking is performed in a tire, there are a type in which marking is required in determined phases of a tire, and a type in which marking is allowed to be performed on arbitrary phases on a sidewall.

In a case where a plurality of marks are formed in a tire, it is known that a plurality of marks are formed in a sidewall of a tire with positions being shifted from each other in a radial direction of the tire, or a plurality of marks are formed with positions being shifted from each other in a circumferential direction. Increasing the number of marks by combining shifting the positions from each other in the radial direction of the tire and shifting the positions from each other in the circumferential direction is also known.

For example, in PTL 1 or the like, as this type of marking apparatus, a tire is pinched between an upper rim and a lower rim that are movable in an upward-downward direction, and the tire is rotated in the circumferential direction by rotating both of the rims around an axis of the tire. By rotating the tire, the positions where marking is performed in the tire are shifted from each other in the circumferential direction.

The marking is performed by a printing part of the marking apparatus. In the printing part, a marking head is heated by a heating block, and is biased in a direction away from the tire by a spring. By pushing in the marking head against a spring force using a driving cylinder, the marking head can press a predetermined surface of the tire via a marking tape, and attach marks through heat transfer.

### CITATION LIST

### Patent Literature

[PTL 1] Japanese Unexamined Patent Application Publication No. 2002-122500

### SUMMARY OF INVENTION

### Technical Problem

However, in a case where a plurality of marks are formed in a tire, there is a problem in that the configuration of the marking apparatus becomes complicated in order to shift the positions where marking is performed in the tire from each other.

The invention has been made in view of such problems, and an object thereof is to provide a tire marking apparatus that can rotate a tire with respect to a printing part with a simple configuration.

### Solution to Problem

In order to solve the above problems, the invention suggests the following means.

A tire marking apparatus of one aspect of the invention is a tire marking apparatus for performing marking in a tire, including a printing part capable of performing printing in a tire; a rotational position adjusting roller that abuts against a portion of the tire, and rotates the tire around an axis of the tire when the rotational position adjusting roller rotates; and a rotational driving unit that rotates the rotational position adjusting roller.

According to this aspect, the tire can be rotated around its axis by including the rotational position adjusting roller and the rotational driving unit. If the tire rotates around its axis, the circumferential positions of the tire that are marked by the printing part are shifted from each other.

Additionally, in the above tire marking apparatus, the rotational driving unit may include a linear motion part that is driven to move forward and backward on a cylinder axis, and a converting unit that converts a force for the forward and backward movement driving of the linear motion part into the rotative force of the rotational position adjusting roller in one direction.

According to this aspect, the rotational position adjusting roller can be rotated in the one direction by converting the movement in which the linear motion part is driven to move forward and backward on the cylinder axis, using the converting unit.

Additionally, in the above tire marking apparatus, the converting unit may include a rotation transmission unit that allows the rotation of the rotational position adjusting roller in only the one direction. The rotational position adjusting roller may be rotated in the one direction by the forward movement of the linear motion part, and the rotational position adjusting roller may be idled in the backward movement of the linear motion part.

According to this aspect, the rotational position adjusting roller can be rotated in only the one direction by repeatedly moving the linear motion part forward.

Additionally, the above tire marking apparatus may further include a centering mechanism that makes rollers abut against the tread of the tire from a plurality of circumferential positions to adjust the position of the tire, and at least one of the rollers of the centering mechanism may constitute the rotational position adjusting roller.

According to this aspect, since the roller of the centering mechanism that adjusts the position of the tire also serves as the rotational position adjusting roller, the tire can be rotated simply by the addition of simple functions in a case where the tire marking apparatus includes the centering mechanism.

Additionally, the above tire marking apparatus may further include a rotational amount detecting unit that detects a rotational amount by which the tire rotates around the axis of the tire; and a linear motion controller that controls the linear motion part on the basis of a detection result of the rotational amount detecting unit. The linear motion controller may make the linear motion part move forward again in a case where the rotational amount of the tire detected by the rotational amount detecting unit is smaller than a target rotational amount.

According to this aspect, even in a case where there is slipping between the rotational position adjusting roller and the tire and the tire does not sufficiently rotate, the rotational amount of the tire can be adjusted so as to become the target rotational amount.

Additionally, the above tire marking apparatus may further include a conveying unit including a first roller having a side surface capable of abutting against one side of a sidewall of the tire with respect to the axis of the tire, a second roller having a side surface capable of abutting against the other side thereof with respect to the axis of the tire, and a conveyance driving unit that rotates the first roller around an axis of the first roller and rotates the second roller around an axis of the second roller, and conveying the tire. The conveyance driving unit may rotate the first roller in a normal direction around the axis of the first roller and may rotate the second roller in a reverse direction around the axis of the second roller. The first roller and the second roller may constitute the rotational position adjusting roller.

According to this aspect, since the conveyance driving unit rotates the first roller in the normal direction and rotates the second roller in the reverse direction, the tire on the first roller and the second roller rotates around its axis. Since the first roller and the second roller of the conveying unit also serve as the rotational position adjusting rollers, the configuration of the tire marking apparatus can be simplified even in a case where the tire marking apparatus includes the conveying unit.

### Advantageous Effects of Invention

According to the tire marking apparatus of the invention, the tire can be rotated with respect to the printing part with a simple configuration.

### BRIEF DESCRIPTION OF DRAWINGS

FIG. 1 is a view illustrating the outline of an overall configuration of a tire marking apparatus of an embodiment of the invention.

FIG. 2 is a block diagram of the tire marking apparatus.

FIG. 3 is a plan view of a conveying lane of the tire marking apparatus.

FIG. 4 is a front view of the integrated conveying lane.

FIG. 5 is a view illustrating the internal structure of a first positioning unit of the integrated conveying lane.

FIG. 6 is a perspective view of a driving roller of the first positioning unit.

FIG. 7 is a plan view of a holding arm and a rotational driving unit of the integrated conveying lane.

FIG. 8 is a front view of a rotational amount detecting unit of the tire marking apparatus.

FIG. 9 is a front view when a head unit and a ribbon supplying and winding unit of the tire marking apparatus are partially broken.

FIG. 10 is a side view when the head unit and the ribbon supplying and winding unit are partially broken.

FIG. 11 is a view schematically illustrating a converting unit of the tire marking apparatus in a modification example of the embodiment of the invention.

FIG. 12 is a view schematically illustrating the operation of the converting unit.

### DESCRIPTION OF EMBODIMENTS

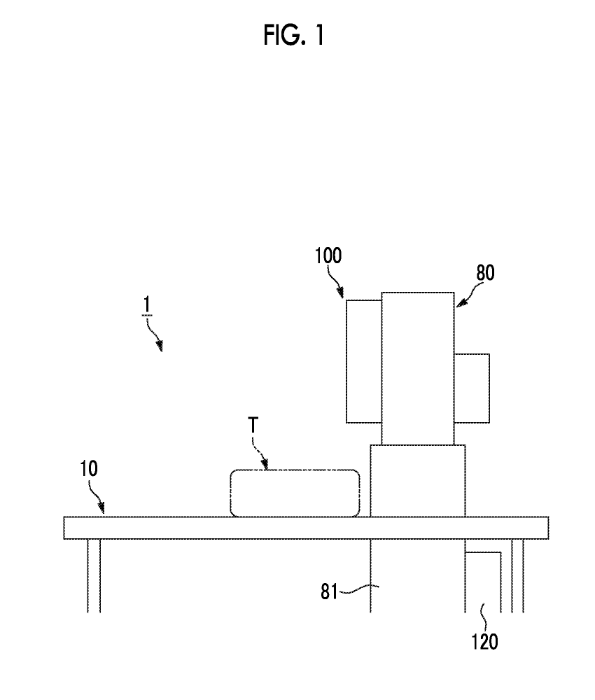

Hereinafter, an embodiment of a tire marking apparatus related to the invention will be described, referring to FIGS. 1 to 12.

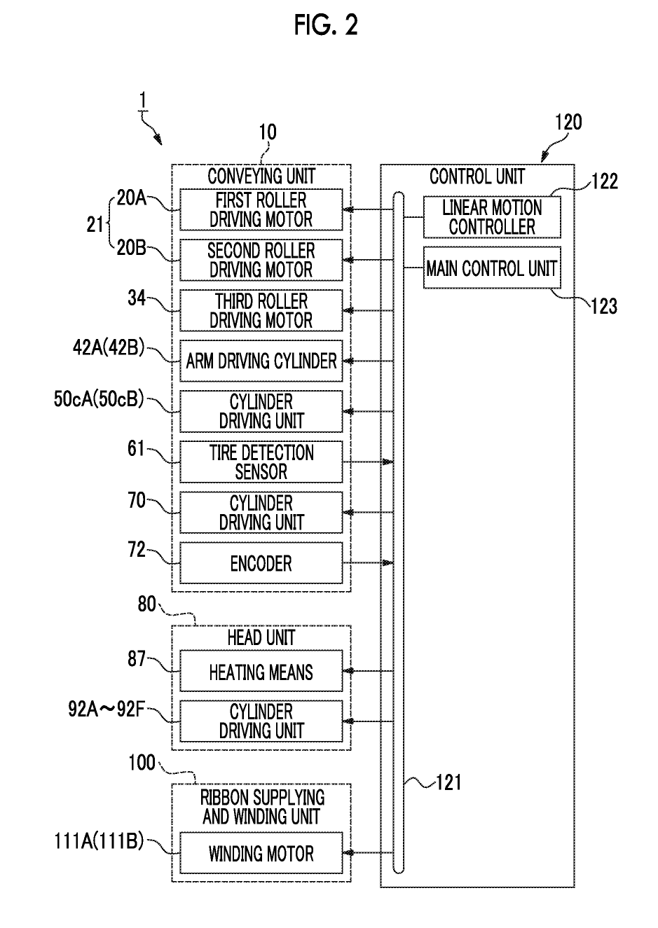

As illustrated in FIGS. 1 and 2, a marking apparatus 1 of the present embodiment is configured to perform marking (printing) in a tire T, and includes a conveying unit 10 that supports and conveys the tire T from below, a head unit 80 that is arranged above the conveying unit 10, a ribbon supplying and winding unit 100 that is attached to the head unit 80, and a control unit 120 that controls the conveying unit 10, the head unit 80, and the ribbon supplying and winding unit 100.

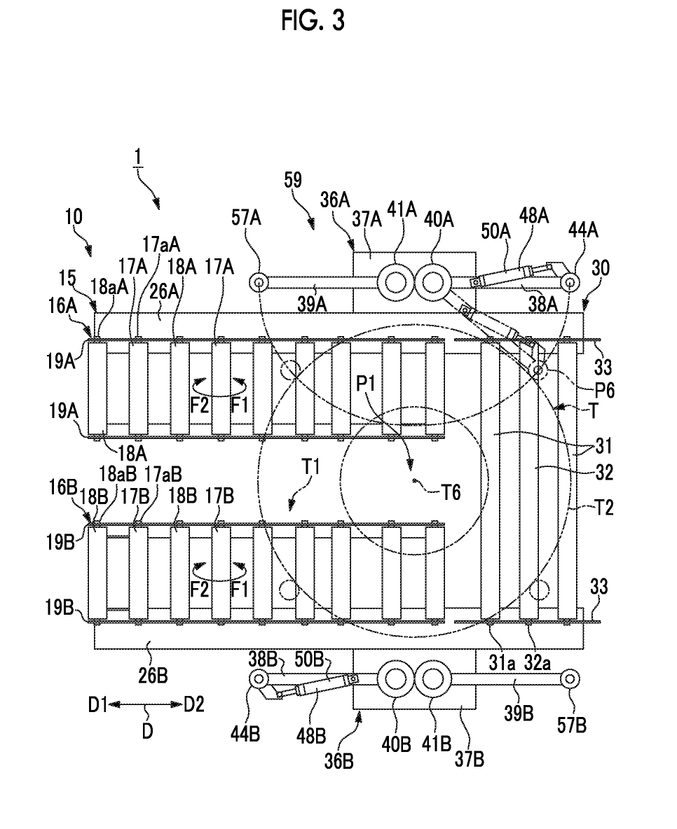

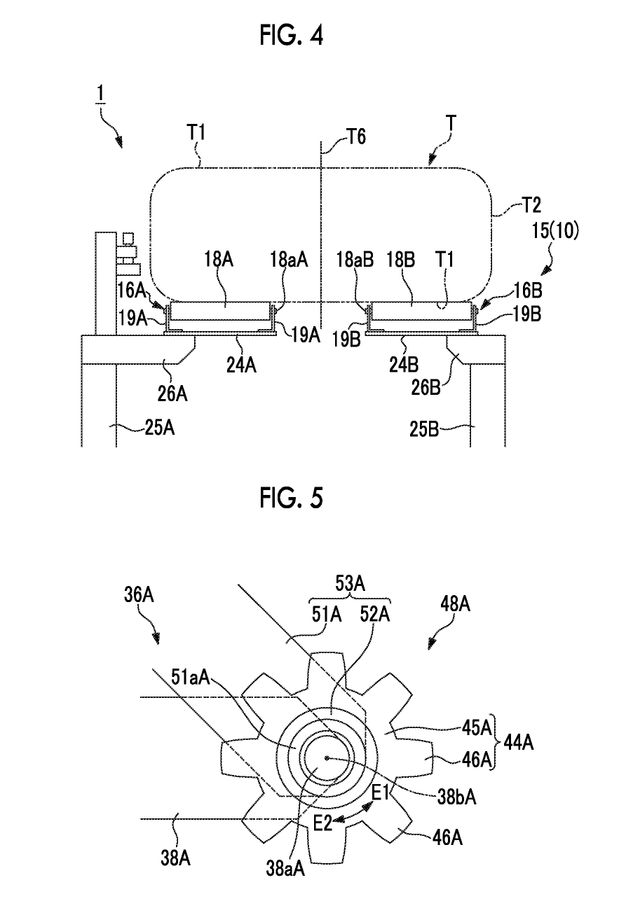

As illustrated in FIGS. 3 and 4, the conveying unit 10 has a split conveying lane 15 in which a first conveying lane 16A and a second conveying lane 16B are arranged side by side in a width direction of the conveying unit 10 on an upstream side D1 in the conveying direction D of the conveying unit 10, and an integrated conveying lane 30 that is arranged on a downstream side D2 in the conveying unit 10. Since the configurations of the first conveying lane 16A and the second conveying lane 16B are the same in the present embodiment, the configuration of the first conveying lane 16A will be illustrated by adding the English capital letter “A” to figures or English lower case letters, and the configuration corresponding to the second conveying lane 16B will be illustrated by adding the English capital letter “B” to figures or English lower case letters. Accordingly, overlapping description will be omitted. Positioning units 36A and 36B, printing pins 83A to 83F, ribbon supplying units 101A and 101B, and the like to be described below will be described similarly.

For example, the configurations of a first driving roller 17A and a second driving roller 17B (to be described below) of the first conveying lane 16A are the same.

In the first conveying lane 16A, each first driving roller (first roller) 17A and each first driven roller 18A are rotatably supported by support members 19A at both ends in the width direction around their respective axes 17aA and 18aA. The height of an upper surface of the first driving roller 17A and the height of an upper surface of the first driven roller 18A substantially coincide with each other, or the upper surface of the first driving roller 17A is arranged to be slightly higher. The first driving roller 17A and the first driven roller 18A are alternately arranged along the conveying direction D. The first driving roller 17A and the first driven roller 18A are arranged on the same plane where the axes 17aA and 18aA are parallel to the horizontal plane.

A belt that is not illustrated is connected to the respective first driving rollers 17A. A rotating shaft of a first roller driving motor 20A illustrated in FIG. 2 is connected to this belt. The rotating shaft of the first roller driving motor 20A can be driven so as to be switched to a normal direction (first direction) and a reverse direction (second direction). The first roller driving motor 20A and a second roller driving motor 20B constitute a conveyance driving unit 21.

As illustrated in FIGS. 3 and 4, the tire T is arranged on the respective first driving rollers 17A, the respective first driven rollers 18A, the respective second driving rollers (second rollers) 17B, and the respective second driven rollers 18B. In this case, the tire T is arranged so that a side surface of at least the first driving roller 17A abuts against one side of a sidewall T1 of the tire T with respect to an axis T6 of the tire T and a side surface of the first driven roller 18A auxiliarily abuts against the one side. The tire T is arranged so that a side surface of at least the second driving roller 17B abuts against the other side of the sidewall T1 with respect to the axis T6 and a side surface of the second driven roller 18B auxiliarily abuts against the other side. The rollers 17A and 18A and the rollers 17B and 18B abut against the one sidewall T1 of the tire T, respectively.

By rotating the rotating shaft of the first roller driving motor 20A in the normal direction, as illustrated in FIG. 3, each first driving roller 17A rotates in a normal direction F1 around its axis 17aA. By rotating the rotating shaft of the second roller driving motor 20B in the normal direction, each second driving roller 17B rotates in the normal direction F1 around its axis 17aB. In this case, the tire T arranged on the respective driving rollers 17A and 17B is conveyed from the upstream side D1 toward the downstream side D2. Each first driven roller 18A and each second driven roller 18B that support the tire T to be conveyed performs the corotation of rotating according to the movement of the tire T.

In this way, the driving rollers 17A and 17B are rollers that rotationally drive the tire T, and the driven rollers 18A and 18B are rollers that are driven according to the rotating tire T.

On the other hand, if the rotating shafts of the roller driving motors 20A and 20B are rotated in the reverse direction, the first driving roller 17A rotates in a reverse direction F2 around its axis 17aA, and the second driving roller 17B rotates in the reverse direction F2 around its axis 17aB. In this case, the tire T arranged on the respective driving rollers 17A and 17B is conveyed from the downstream side D2 toward the upstream side D1.

In the first conveying lane 16A, as illustrated in FIGS. 3 and 4, the pair of support members 19A are connected together by a coupling member 24A.

The coupling member 24A is attached to a support member 26A provided at a leg 25A extending in an upward-downward direction. As a lower end of the leg 25A is arranged on a floor surface (not illustrated), the first conveying lane 16A is supported at a position separated upward from the floor surface.

The integrated conveying lane 30 is configured similar to the integrated conveying lanes 16A and 16B. That is, as illustrated in FIG. 3, in the integrated conveying lane 30, each third driving roller 31 and each third driven roller 32 are supported by the support members 33 at both ends in the width direction so as to be rotatable around their respective axes 31a and 32a. The support members 33 are attached to the aforementioned support members 26A and 26B.

A belt that is not illustrated is connected to the respective third driving rollers 31. A rotating shaft of a third roller driving motor 34 (refer to FIG. 2) is connected to this belt. The rotating shaft of the third roller driving motor 34 can be driven so as to be switched to the normal direction and the reverse direction.

The support member 26A is provided with the first positioning unit 36A.

In the first positioning unit 36A, a pair of holding arms 38A and 39A are supported on a supporting base 37A so as to be rotatable (rockable) about first ends of the holding arms 38A and 39A. The holding arms 38A and 39A can be rotated on a plane parallel to the horizontal plane about on their respective first ends via gears 40A and 41A by an arm driving cylinder 42A (refer to FIG. 2). The holding arm 38A is arranged closer to the downstream side D2 than the holding arm 39A.

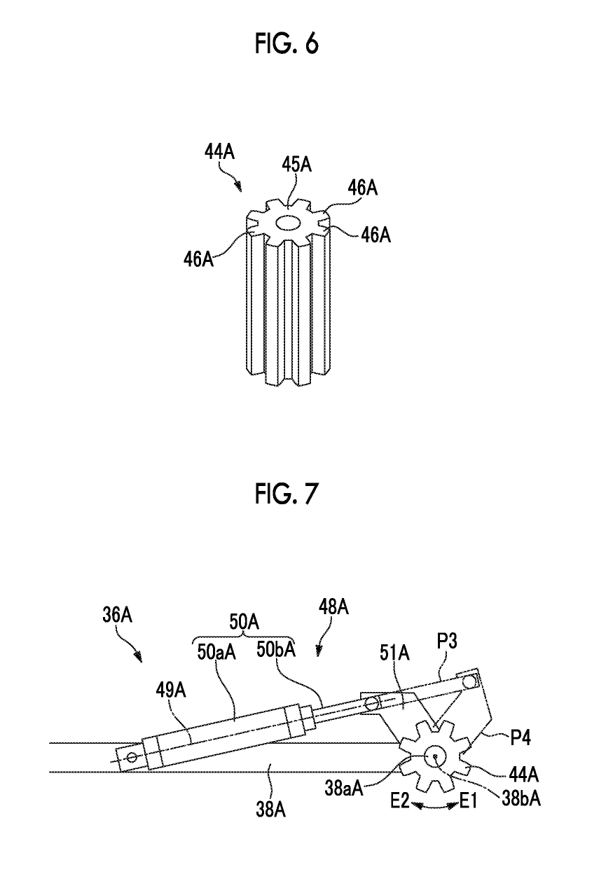

As illustrated in FIG. 5, a second end of the holding arm 38A is provided with a columnar shaft member 38aA. A driving roller (a rotational position adjusting roller, a roller) 44A illustrated in FIGS. 5 and 6 is rotatably supported by the shaft member 38aA. The driving roller 44A is supported so as to be rotatable around an axis orthogonal to the horizontal plane.

As illustrated in FIGS. 5 and 6, the driving roller 44A has a cylindrical roller body 45A, and a plurality of outside protrusions 46A that protrude from an outer peripheral surface of the roller body 45A and extend along an axis of the roller body 45A. The plurality of outside protrusions 46A are arranged so as to be separated from each other in a circumferential direction of the roller body 45A.

The roller body 45A and the outside protrusions 46A that constitute the driving roller 44A can be configured using a timing pulley made of steel, or can be integrally formed of resin, such as nylon or polyoxymethylene (POM).

In addition, the driving roller 44A may be configured so as not to include the plurality of outside protrusions 46A, and materials in which the frictional coefficient of the outer peripheral surface of the roller body 45A becomes large may be used for the driving roller 44A.

As illustrated in FIG. 7, a rotational driving unit 48A for rotating the driving roller 44A is attached to the holding arm 38A.

The rotational driving unit 48A, as illustrated in FIGS. 5 and 7, has an air cylinder (linear motion part) 50A that is driven to move forward and backward on a cylinder axis 49A, a link member 51A that is rotatably connected to a tip part of the air cylinder 50A in a forward movement direction, and a well-known clutch mechanism (rotation transmission part) 52A that is attached to the link member 51A. In addition, the link member 51A and the clutch mechanism 52A constitute a converting unit 53A.

The air cylinder 50A, as illustrated in FIG. 7, is configured so that a rod 50bA is inserted into a cylinder body 50aA so as to be capable of moving forward and backward with respect to the cylinder body 50aA. A cylinder driving unit 50cA (refer to FIG. 2), such as an air compressor, capable of supplying and discharging compressed air, is connected to the cylinder body 50aA via a tube (not illustrated).

If compressed air is supplied to a head side within the cylinder body 50aA by the cylinder driving unit 50cA, the rod 50bA moves forward with respect to the cylinder body 50aA. On the other hand, if compressed air is supplied to a rod side within the cylinder body 50aA by the cylinder driving unit 50cA, the rod 50bA moves backward with respect to the cylinder body 50aA.

In addition, in the present embodiment, the air cylinder 50A that is a linear motion part is driven with compressed air. However, the linear motion part may be driven with hydraulic pressure, magnetism, or the like.

A tip part of the rod 50bA in the forward movement direction and a first end of the link member 51A are rotatably connected together with a pin of which the reference sign is omitted.

As illustrated in FIG. 5, a second end 51aA of the link member 51A is formed in a cylindrical shape. The shaft member 38aA of the holding arm 38A is inserted into a tube hole of the second end 51aA so as to be rotatable with respect to the second end 51aA. The aforementioned clutch mechanism 52A is fixed to an outer peripheral surface of the second end 51aA. The clutch mechanism 52A is arranged within a tube hole of the roller body 45A of the driving roller 44A.

The clutch mechanism 52A restricts that the driving roller 44A rotates in a direction (one direction) E1 around an axis 38bA of the shaft member 38aA with respect to the clutch mechanism 52A. On the other hand, the clutch mechanism allows the driving roller 44A to rotate in a direction E2 around the axis 38bA with respect to the clutch mechanism 52A.

In the rotational driving unit 48A configured in this way, if the rod 50bA moves forward as illustrated by a position P3 of FIG. 7 with respect to the cylinder body 50aA, the link member 51A rotates in the direction E2 around the axis 38bA, and moves to a position P4. In this case, the clutch mechanism 52A and the driving roller 44A are connected together, and the clutch mechanism 52A and the driving roller 44A rotate in the direction E2 around the axis 38bA together with the second end 51aA of the link member 51A.

On the other hand, if the rod 50bA has moved backward with respect to the cylinder body 50aA, the link member 51A rotates in the direction E1 around the axis 38bA. In this case, the connection between the clutch mechanism 52A and the driving roller 44A is released, and the driving roller 44A does not rotate (idles).

In addition, a configuration may be adopted such that the driving roller 44A does not rotate when the rod 50bA moves forward and the driving roller 44A rotates when the rod 50bA moves backward.

In this way, the clutch mechanism 52A allows the rotation of the driving roller 44A only in the direction E2 around the axis 38bA with respect to the second end 51aA of the link member 51A.

The converting unit 53A converts a force for the forward and backward movement driving of the air cylinder 50A into the rotative force of the driving roller 44A in the direction E2 around the axis 38bA.

The rotational driving unit 48A includes the air cylinder 50A and the converting unit 53A, and the driving roller 44A rotates in the direction E2 by movement in which the air cylinder 50A is driven to move forward and backward on the cylinder axis 49A being converted by the converting unit 53A.

If the cylinder driving unit 50cA performs forward movement and backward movement of the rod 50bA, the driving roller 44A rotates at a constant angle around the axis 38bA.

By repeating a set of forward movement and backward movement of the rod 50bA a predetermined number of times, so-called predetermined inching-driving in which the driving roller 44A rotates a predetermined multiple number of times at a constant angle is performed.

A driven roller 57A illustrated in FIG. 3 is rotatably supported by the second end of the holding arm 39A. The driven roller 57A is driven according to the tire T that rotates as will be described below.

The support member 26B is provided with a second positioning unit 36B. The first positioning unit 36A and the second positioning units 36B constitute a centering mechanism 59.

The holding arm 38B of the second positioning unit 36B is arranged closer to the upstream side D1 than the holding arm 39B.

The first positioning unit 36A and the second positioning unit 36B are arranged so as to face each other at the end of the split conveying lane 15 on the downstream side D2 interposed therebetween.

In the centering mechanism 59 configured in this way, a tire detecting sensor 61 (refer to FIG. 2) detects that the tire T conveyed by the conveying unit 10 has arrived at a marking position P1 specified between the first positioning unit 36A and the second positioning unit 36B. As the tire detecting sensor 61, well-known contact type or non-contact-type sensors can be appropriately selected and used.

The tire detecting sensor 61 transmits the detection result to the control unit 120.

When the tire detecting sensor 61 detects that the tire T has arrived at the marking position P1, the following control is performed.

In addition, at a normal time when the centering mechanism 59 does not adjust the position of the tire T, the holding arms 38A, 39A, 38B, and 39B are arranged so as to become parallel to the conveying direction D of the tire T, and there is no hindrance to conveyance of the tire T.

The arm driving motors 40A, 41A, 40B, and 41B are driven to rotate the holding arms 38A, 39A, 38B, and 39B in order to make the rollers 44A, 57A, 44B, and 57B abut against a tread T2 of the tire T from a plurality of positions in the circumferential direction.

If the driving rollers 44A and 44B are rotated through inching-driving by the cylinder driving units 50cA and 50cB, the tire T rotates in a predetermined direction around the axis T6.

If the tire T rotates, the driven rollers 57A and 57B are driven and corotated.

The position of the axis T6 of the tire T is adjusted (the tire T is aligned) by inching-driving the driving rollers 44A and 44B.

In this way, in the present embodiment, the driving rollers 44A and 44B of the centering mechanism 59 that adjusts the position of the tire T also serve as rotational position adjusting rollers that rotate the tire T around the axis T6.

In addition, in the present embodiment, the tire T is rotated around the axis T6 with the driving forces of the two driving rollers 44A and 44B of the centering mechanism 59. However, the number of driving rollers that drive the tire T is not limited to this, and one driving roller may be used or three or more driving rollers may be used.

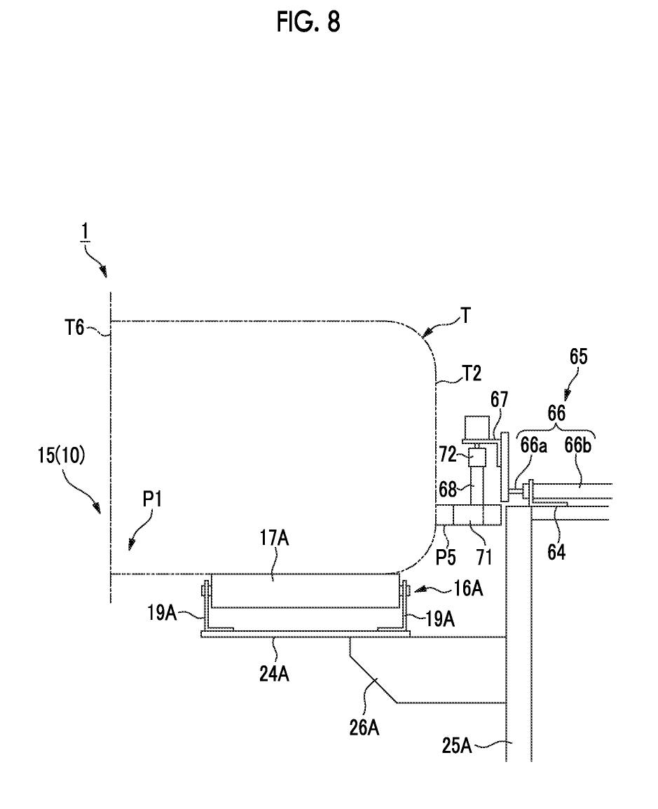

As illustrated in FIG. 8, a rotational amount detecting unit 65 is attached to the leg 25A via a support member 64.

In the rotational amount detecting unit 65, a rotating shaft 68 is attached to a tip part of a rod 66a of an air cylinder 66 via a coupling member 67. The rod 66a is inserted into a cylinder body 66b of the air cylinder 66 so as to be capable of moving forward and backward. The cylinder body 66b is fixed to the leg 25A by the aforementioned support member 64.

A cylinder driving unit 70 (refer to FIG. 2) is connected to the cylinder body 66b via a tube (not illustrated).

If compressed air is supplied to a head side within the cylinder body 66b by the cylinder driving unit 70, the rod 66a moves forward with respect to the cylinder body 66b. On the other hand, if compressed air is supplied to a rod side within the cylinder body 66b by the cylinder driving unit 70, the rod 66a moves backward with respect to the cylinder body 66b.

The rotating shaft 68 is arranged so as to be orthogonal to the horizontal plane. The rotating shaft 68 is supported by the coupling member 67 so as to be rotatable around an axis of the rotating shaft 68.

A detection roller 71 is attached to a lower end of the rotating shaft 68, and an encoder 72 is attached to an upper part of the rotating shaft. When the rod 66a has moved forward, the detection roller 71 moves to a position P5, and a side surface of the detection roller 71 abuts against the tread T2 of the tire T at the marking position P1. There is a constant relationship between the rotational amount (rotational angle) by which the tire T rotates around the axis T6 and the rotational amount by which the rotating shaft 68 rotates around its axis.

The encoder 72 detects the rotational amount of the rotating shaft 68 and corrects the detection result to detect the rotational amount of the tire T. The encoder 72 transmits the detection result to the control unit 120.

The head unit 80, as illustrated in FIGS. 1, 9, and 10, has a base 82 supported on a supporting base 81, six printing pins (printing parts) 83A to 83F supported by the base 82, and six air cylinders 84A to 84F that are driven to move the printing pins 83A to 83F forward and backward. In addition, the printing pins 83A to 83F are short for the printing pins 83A, 83B, 83C, 83D, 83E, and 83F. The same applies to the air cylinders 84A to 84F or the like.

The printing pins 83A to 83F are formed in the shape of a rod that extends in an upward-downward direction. The printing pins 83A to 83F are arranged in a grid pattern so that the printing pins 83A, 83B, and 83C constitute one overlapping row as viewed from a side surface and so that the printing pins 83D, 83E, and 83F constitute the other overlapping one row as viewed from the side surface. As viewed from the front, the printing pin 83A and the printing pin 83D, the printing pin 83B and the printing pin 83E, and the printing pin 83C and the printing pin 83F overlap each other, respectively.

The printing pin 83B is formed linearly. The printing pins 83A and 83C are formed such that central parts thereof in a longitudinal direction are bent in the shape of a crank. Accordingly, the pitch of lower ends of the printing pins 83A, 83B, and 83C is smaller compared to the pitch of upper ends thereof. Although not illustrated, shapes protruding from end surfaces, such as circular shapes or triangular shapes, are formed in lower surfaces of the printing pins 83A, 83B, and 83C.

The printing pins 83D, 83E, and 83F are configured similar to the printing pins 83A, 83B, and 83C.

An upper end of the printing pin 83A is provided with a diameter-enlarged part 83aA (diameter-enlarged parts 83aD, 83aE, and 83aF are not illustrated).

The printing pins 83A to 83F are guided by guide holes (not illustrated), which are formed in a heating block 86 attached to the base 82, so as to move forward and backward in the upward-downward direction with respect to the base 82. Heating means 87 (refer to FIG. 2) having a heater or the like is arranged within the heating block 86. The heating means 87 applies predetermined electric power to the heater, thereby heating the printing pins 83A to 83F inserted through the guide holes. A guide plate 88 is arranged below the heating block 86, and the guide plate 88 is attached to the base 82. A through-hole 88a through which the lower ends of the printing pins 83A to 83F are insertable is formed in the guide plate 88.

A coil spring 90A is arranged between a lower surface of the diameter-enlarged part 83aA of the printing pin 83A and an upper surface of the heating block 86 (coil springs 90D, 90E, and 90F are not illustrated). The coil spring 90A is inserted through the printing pin 83A. The coil spring 90A biases the printing pin 83A upward. In a state where the air cylinder 84A does not bias the printing pin 83A downward, a lower surface of the printing pin 83A is arranged above a lower surface of the guide plate 88.

The air cylinder 84A is configured so that a rod 84bA is inserted through a cylinder body 84aA so as to be capable of moving forward and backward within the cylinder body 84aA (cylinder bodies 84aD, 84aE, 84aF, rod 84bD, 84bE, and 84bF are not illustrated).

The cylinder body 84aA is attached to the base 82. A cylinder driving unit 92A (refer to FIG. 2) is connected to the cylinder body 84aA via a tube (not illustrated).

If compressed air is supplied to a head side within the cylinder body 84aA by the cylinder driving unit 92A, the rod 84bA downwardly moves forward with respect to the cylinder body 84aA. In this case, the lower surface of the printing pin 83A protrudes below the lower surface of the guide plate 88 by moving the printing pin 83A forward against the biasing force of the coil spring 90A. When the heated printing pin 83A presses an ink ribbon R1 (to be described below) against the sidewall T1 of the tire T, marking is performed in the tire T.

On the other hand, if compressed air is supplied to a rod side within the cylinder body 84aA by the cylinder driving unit 92A, the biasing force of the coil spring 90A is received and the rod 84bA upwardly moves backward with respect to the cylinder body 84aA.

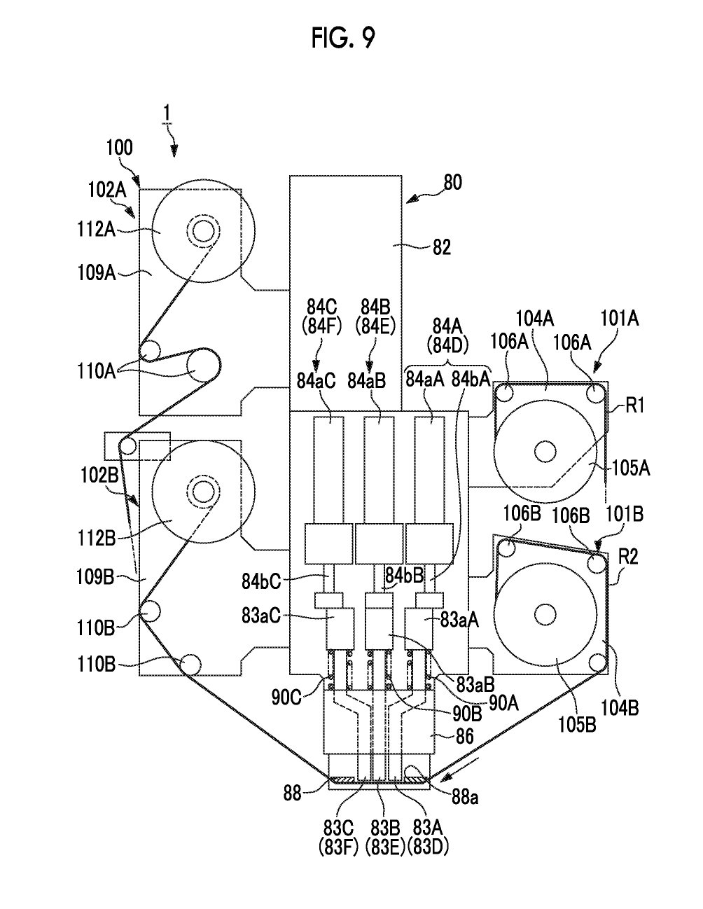

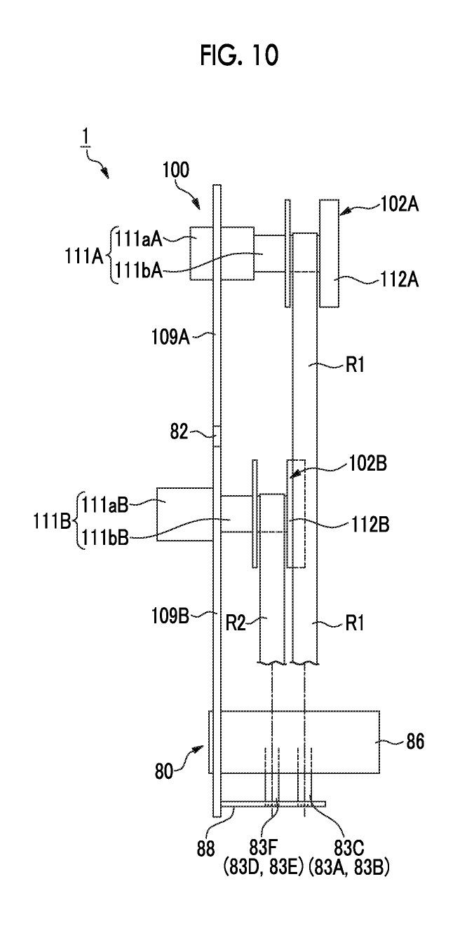

The ribbon supplying and winding unit 100, as illustrated in FIGS. 9 and 10, has the ribbon supplying units 101A and 101B fixed to the base 82 of the head unit 80, and ribbon winding units 102A and 102B.

In the ribbon supplying unit 101A, a supply roller 105A and a guide roller 106A are rotatably supported by an auxiliary base 104A fixed to the base 82. For example, a red ink ribbon R1 is wound around the supply roller 105A. A heat transfer type ribbon to which ink is transferred by being pressed and heated is used as the ink ribbon R1.

The ink ribbon R1 wound out from the supply roller 105A is guided to the lower surface of the guide plate 88 after being wound around the guide roller 106A so that constant tension acts on the ink ribbon R1.

The ink ribbon R1 faces lower surfaces of the printing pins 83A, 83B, and 83C across the through-hole 88a of the guide plate 88.

For example, a yellow ink ribbon R2 is wound around a supply roller 105B of the ribbon supplying unit 101B. A plane in which the supply roller 105B rotates and a plane in which the supply roller 105A rotates are shifted from each other in a thickness direction of the base 82, that is, in a width direction of the ink ribbons R1 and R2.

The ink ribbon R2 faces lower end surfaces of the printing pins 83D, 83E, and 83F across the through-hole 88a of the guide plate 88.

In the ribbon winding unit 102A, the guide roller 110A is rotatably supported by an auxiliary base 109A fixed to the base 82, and a main body 111aA of a winding motor 111A is fixed to the auxiliary base. A winding roller 112A is connected to a rotating shaft 111bA of the winding motor 111A. The ink ribbon R1 is wound around the winding roller 112A.

The ink ribbon R1 sent out from the guide plate 88 is wound around the winding roller 112A after being wound around the guide roller 110A.

Meanwhile, the ink ribbon R2 is wound around the winding roller 112B.

The control unit 120, as illustrated in FIG. 2, has a linear motion controller 122 and a main controller 123 that are connected to a bus 121. The roller driving motors 20A, 20B, and 34 of the conveying unit 10, the arm driving cylinders 42A and 42B, the cylinder driving units 50cA, 50cB, 70, the tire detecting sensor 61, the encoder 72, the heating means 87 of the head unit 80, the cylinder driving units 92A to 92F, and the winding motors 111A and 111B of the ribbon supplying and winding unit 100 are connected to the bus 121.

The linear motion controller 122 and the main controller 123 are respectively constituted of a timer, an arithmetic element, a memory, a control program, or the like.

The linear motion controller 122 drives the cylinder driving units 50cA and 50cB to control the air cylinders 50A and 50B, on the basis of the detection result of the encoder 72 of the rotational amount detecting unit 65.

The main controller 123 controls the roller driving motors 20A, 20B, and 34 or the like other than the cylinder driving units 50cA and 50cB.

Next, the operation of the marking apparatus 1 configured as described above will be described. If the marking apparatus 1 is started, the main controller 123 of the control unit 120 rotates the rotating shafts of the roller driving motors 20A, 20B, and 34 in the normal direction. The driving rollers 17A, 17B, and 31 rotate in the normal direction F1. By heating the heating block 86 by the heating means 87, the printing pins 83A to 83F are heated to a predetermined temperature.

The tire T that has finished a predetermined test and inspection using a testing device, such as a tire uniformity machine, is arranged on the split conveying lane 15.

The tire T is arranged on the split conveying lane 15 in a state where circumferential positions where marking is performed are adjusted by the testing device.

The tire T is conveyed from the upstream side D1 toward the downstream side D2 by the driving rollers 17A and 17B. Information, such as the external diameter of the tire T, the shape or color of marking performed in the tire T, and the like, is transmitted from the testing device to the control unit 120 of the marking apparatus 1.

In this example, description will be made supposing that the instruction of marking two kinds of shapes with mutually different colors in the tire T is transmitted from the testing device.

If the tire T is conveyed to the marking position P1, the tire detecting sensor 61 detects that the tire T has arrived at the marking position P1, and transmits the detection result to the linear motion controller 122 and the main controller 123 of the control unit 120.

The linear motion controller 122 drives the arm driving cylinders 42A and 42B, and makes the rollers 44A, 57A, 44B, and 57B abut against the tread T2 of the tire T. In this case, the rollers 44A, 57A, 44B, and 57B move to the position P6 of FIG. 3.

In order to perform first marking, the cylinder driving unit 92A is driven to move the printing pin 83A forward together with the rod 84bA of the air cylinder 84A. By the ink ribbon R1 being pressed and heated, for example, marking of red circular shapes is performed on the sidewall T1 of the tire T. The winding motor 111A is driven to rotate the winding roller 112A in order to wind the ink ribbon R1 around the winding roller 112A with a fixed length.

Next, in order to perform second marking, the position of the tire T is adjusted by driving the cylinder driving units 50cA and 50cB and inching-driving the driving rollers 44A and 44B. By the outside protrusion 46A being formed in the driving roller 44A, the frictional force between the driving roller 44A and the tire T can be enhanced.

If the driving rollers 44A and 44B rotate the tire T around the axis T6, the driven rollers 57A and 57B are driven and rotated according to the rotating tire T. If the main controller 123 drives the cylinder driving unit 70 to move the rod 66a forward, the side surface of the detection roller 71 abuts against the tread T2 of the tire T.

The linear motion controller 122 inching-drives the driving rollers 44A and 44B a predetermined number of times, and rotates the tire T around the axis T6 by a predetermined target rotational amount. In this case, the detection roller 71 that has abutted against the tire T rotates around its axis. The rotational amount detecting unit 65 detects the rotational amount of the tire T, converts the detected rotational amount of the tire T into a signal to transmit the signal to the linear motion controller 122, and checks whether the tire has been rotated by the predetermined target rotational amount.

When this rotational amount is smaller than the target rotational amount, even if the driving rollers 44A and 44B are inching-driven, it is considered that there is slipping between the driving rollers 44A and 44B and the tire T and the tire T does not sufficiently rotate. In this case, the linear motion controller 122 further drives the cylinder driving units 50cA and 50cB to move the rods 50bA and 50bB of the air cylinders 50A and 50B forward.

In addition, thereafter, further detecting the rotational amount of the tire T by the rotational amount detecting unit 65 and moving the air cylinders 50A and 50B forward on the basis of the detection result may be repeatedly performed.

Additionally, as the external diameter of the tire T becomes large, the rotational amount (angle) by which the tire T rotates around the axis T6 becomes small when the driving rollers 44A and 44B have been inching-driven a predetermined number of times. For this reason, as the external diameter of the tire T becomes large, the number of times of inching-driving may be increased.

According to distances between the tire T, the axis T6, and a position where marking is performed in the sidewall T1 of the tire T, the number of times by which the driving rollers 44A and 44B are inching-driven may be changed.

The main controller 123, for example, drives the cylinder driving unit 92E to move the printing pin 83E forward. As the ink ribbon R2 is pressed and heated, for example, marking of yellow triangular shapes is performed at positions that are different in the circumferential direction from the marking of the circular shapes in the sidewall T1 of the tire T.

In this way, marking after the second marking can be sequentially performed at a position shifted in the circumferential direction from the position where the first marking is performed in the tire T.

If the main controller 123 drives the cylinder driving unit 70 to move the rod 66a backward, the detection roller 71 is separated from the tread T2 of the tire T.

The linear motion controller 122 drives the arm driving cylinders 42A and 42B to separate the rollers 44A, 57A, 44B, and 57B from the tire T.

The tire T in which two marks have been formed is conveyed from the marking position P1 toward the downstream side D2 by the integrated conveying lane 30.

As described above, according to the marking apparatus 1 of the present embodiment, the tire T can be rotated around the axis T6 by including the driving rollers 44A and 44B and the rotational driving units 48A and 48B. If the tire T rotates around the axis T6, the circumferential positions of the tire T that are marked by the printing pins 83A to 83F are shifted from each other.

In this way, the tire T can be rotated with respect to the printing pins 83A to 83F with a simple configuration.

The rotational driving unit 48A includes the air cylinder 50A and the converting unit 53A, and movement in which the air cylinder 50A is driven to move forward and backward on the cylinder axis 49A is converted by the converting unit 53A. Accordingly, the driving roller 44A can be rotated in the direction E2.

As the marking apparatus 1 includes the clutch mechanism 52A and the air cylinder 50A is repeatedly moved forward and backward, the driving roller 44A can only be rotated in the direction E2.

The driving rollers 44A and 44B of the centering mechanism 59 that adjusts the position of the tire T also serve as the rotational position adjusting rollers that rotate the tire T around the axis T6. Therefore, in a case where the marking apparatus 1 includes the centering mechanism 59, the tire T can be rotated simply by the addition of simple functions instead of the addition of a new device.

The marking apparatus 1 includes the rotational amount detecting unit 65 and the linear motion controller 122. Accordingly, even in a case where there is slipping between the driving rollers 44A and 44B and the tire T and the tire T does not sufficiently rotate, the rotational amount of the tire T can be adjusted so as to become the target rotational amount.

Although the one embodiment of the invention has been described above in detail with reference to the drawings, the specific configuration is not limited to this embodiment, and changes, combinations, deletions, or the like of the configuration are also included without departing from the scope of the invention.

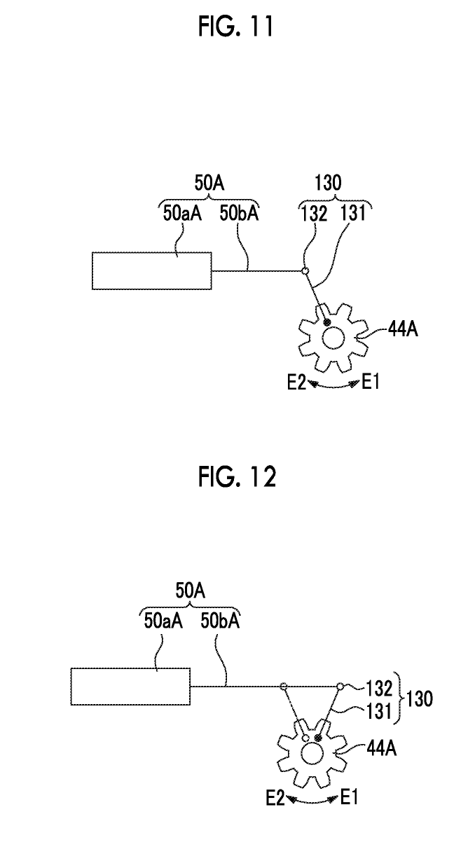

For example, in the above embodiment, the converting unit 53A is the link member 51A and the clutch mechanism 52A. However, the converting unit may be a link mechanism 130 illustrated in FIG. 11. The link mechanism 130 has a link member 131 having a first end attached to the driving roller 44A, and a connecting part 132 that rotatably connects a second end of the link member 131 and a tip part of the rod 50bA.

If the rod 50bA moves forward as illustrated in FIG. 12 from the state illustrated in FIG. 11, the connection angle between the rod 50bA and the link member 131 changes, and the driving roller 44A rotates in the direction E2. On the other hand, if the rod 50bA moves backward as illustrated in FIG. 11, the driving roller 44A rotates in the direction E1.

In the embodiment, it is supposed that the rotational position adjusting rollers are the driving rollers 44A and 44B of the centering mechanism 59. However, the rotational position adjusting rollers are not limited to these, and may be, for example, the first driving roller 17A and the second driving roller 17B of the split conveying lane 15. In this case, the driving rollers 17A and 17B abut against the sidewall T1 of the tire T, and the roller driving motors 20A and 20B become the rotational driving units. As the roller driving motors 20A and 20B rotate the first driving roller 17A in the normal direction F1 around the axis 17aA and rotate the second driving roller 17B in the reverse direction F2 around the axis 17aB, the tire T on the driving rollers 17A and 17B rotates around the axis T6.

Since the driving rollers 17A and 17B of the conveying unit 10 also serve as the rotational position adjusting rollers, the configuration of the marking apparatus 1 can be simplified even in a case where the marking apparatus 1 includes the conveying unit 10.

It is supposed that the rotational amount detecting unit 65 detects the rotation of the detection roller 71 that abuts against the tire T, using the encoder 72. However, the encoder 72 may directly detect the rotation of the driving rollers 44A and 44B of the centering mechanism 59, or may detect the rotation of the rollers 17A, 17B, 18A, and 18B at the marking position P1 of the split conveying lane 15.

In a case where it is considered that the slipping between the driving rollers 44A and 44B and the tire T is neglibly small, the marking apparatus 1 may not include the rotational amount detecting unit 65.

The marking apparatus may also have a form in which a disk part that rotates around a rotating shaft is included, and a plurality of printing pins may be provided at mutual intervals in a circumferential direction of the disk part in the disk part. An air cylinder is provided above one printing pin among the plurality of printing pins, and a printing pin to be pressed by the air cylinder is changed by rotating the disk part around a rotating shaft. Accordingly, the shape of marking performed in the tire T can be changed.

### INDUSTRIAL APPLICABILITY

The invention can be applied to marking apparatuses that rotate a tire to perform marking.

### REFERENCE SIGNS LIST

1 MARKING APPARATUS (TIRE MARKING APPARATUS)
10: CONVEYING UNIT
17A FIRST DRIVING ROLLER (FIRST ROLLER)
17B SECOND DRIVING ROLLER (SECOND ROLLER)
21: CONVEYANCE DRIVING UNIT
44A, 44B: DRIVING ROLLER (ROTATIONAL POSITION ADJUSTING ROLLER, ROLLER)
48A, 48B: ROTATIONAL DRIVING UNIT
49A: CYLINDER AXIS
50A, 50B: AIR CYLINDER (LINEAR MOTION PART)
52A: CLUTCH MECHANISM (ROTATION TRANSMISSION PART)
53A: CONVERTING UNIT
59: CENTERING MECHANISM
65: ROTATIONAL AMOUNT DETECTING UNIT
83A to 83F: PRINTING PIN (PRINTING PART)
122: LINEAR MOTION CONTROLLER
E1: DIRECTION (ONE DIRECTION)
F1: NORMAL DIRECTION
F2: REVERSE DIRECTION
T: TIRE
T1: SIDEWALL
T2: TREAD
T6: AXIS

1. A tire marking apparatus for performing marking in a tire, comprising:
a printing part capable of performing printing in a tire;
a rotational position adjusting roller that abuts against a portion of the tire, and rotates the tire around an axis of the tire when the rotational position adjusting roller rotates; and
a rotational driving unit that rotates the rotational position adjusting roller.

2. The tire marking apparatus according to claim 1,
wherein the rotational driving unit includes
a linear motion part that is driven to move forward and backward on a cylinder axis, and
a converting unit that converts a force for the forward and backward movement driving of the linear motion part into the rotative force of the rotational position adjusting roller in one direction.

3. The tire marking apparatus according to claim 2,
wherein the converting unit includes a rotation transmission unit that allows the rotation of the rotational position adjusting roller in only the one direction, and
wherein the rotational position adjusting roller is rotated in the one direction by the forward movement of the linear motion part, and the rotational position adjusting roller is idled in the backward movement of the linear motion part.

4. The tire marking apparatus according to claim 1, further comprising:
a centering mechanism that makes rollers abut against the tread of the tire from a plurality of circumferential positions to adjust the position of the tire,
wherein at least one of the rollers of the centering mechanism constitutes the rotational position adjusting roller.

5. The tire marking apparatus according to claim 2, further comprising:
a rotational amount detecting unit that detects a rotational amount by which the tire rotates around the axis of the tire; and
a linear motion controller that controls the linear motion part on the basis of a detection result of the rotational amount detecting unit,
wherein the linear motion controller makes the linear motion part move forward in a case where the rotational amount of the tire detected by the rotational amount detecting unit is smaller than a target rotational amount.

6. The tire marking apparatus according to claim 1, further comprising:
a conveying unit including
a first roller having a side surface capable of abutting against one side of a sidewall of the tire with respect to the axis of the tire,
a second roller having a side surface capable of abutting against the other side thereof with respect to the axis of the tire, and
a conveyance driving unit that rotates the first roller around an axis of the first roller and rotates the second roller around an axis of the second roller, and
conveying the tire,
wherein the conveyance driving unit rotates the first roller in a normal direction around the axis of the first roller and rotates the second roller in a reverse direction around the axis of the second roller, and
wherein the first roller and the second roller constitute the rotational position adjusting roller.
